(19) United States
(12) Patent Application Publication
(10) Pub. No.: US 2009/0153532 A1
(43) Pub. Date: Jun. 18, 2009

(54) PIXEL-DRIVING METHOD AND CIRCUIT THEREOF

(75) Inventors: Po-Tsun Chen, Hsinchu County (TW); Ting-Yun Huang, Tainan County (TW); Jie-Jung Huang, Miaoli County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/106,350

(22) Filed: Apr. 21, 2008

(30) Foreign Application Priority Data
Dec. 14, 2007 (TW) 96147948

(51) Int. Cl. G06F 3/038

(52) U.S. Cl. 345/204

(57) ABSTRACT

A method for driving pixel, being compatible between dot-inversion driving mechanism and dual-gate driving mechanism, includes setting four continuous pixels as a driving sub-unit, having a first pixel transistor, a second pixel transistor, a third pixel transistor, and a fourth pixel transistor. The first gate line commonly controls two gates of the first and fourth pixel transistors. The second gate line commonly controls two gates of the second and third pixel transistors. The first source line commonly controls two sources of the first and second pixel transistors. The second source line commonly controls two sources of the third and fourth pixel transistors. A positive voltage and a negative voltage are alternatively in time sequence applied to the first and second source lines, respectively. An activate voltage is alternatively in time sequence applied to the first and second source lines, respectively.

### CROSS-REFERENCE TO RELATED APPLICATION

This application claims the priority benefit of Taiwan application serial no. 96147948, filed on Dec. 14, 2007. The entirety the above-mentioned patent application is hereby incorporated by reference herein and made a part of specification.

### BACKGROUND OF THE INVENTION

1. Field of the Invention

The present invention generally relates to a pixel-driving method and the circuit thereof, and more particularly, to a pixel-driving method and the circuit thereof can adapt dot-inversion driving mechanism and dual-gate driving mechanism being compatible with each other.

2. Description of Related Art

An image frame of a digital display panel is composed of a plurality of color dots arrange in an array, wherein each display dot is corresponding to a pixel. FIG. 1 is a diagram of a conventional pixel circuit. A pixel usually includes a liquid crystal unit 102 and a transistor 100 for controlling the liquid crystal unit. Taking the first pixel thereof as an example, the gate of the transistor 100 is connected to an external gate driver through a gate line G1 for controlling on/off of the pixel. The source of the transistor 100 is connected to an external source driver through a source line S1 for obtaining a gray level voltage corresponding to a data, and the gray level voltage is input into the liquid crystal unit 102 through the drain of the transistor. With a dual-gate driving mechanism, the sources of the liquid crystal units (1) and (2) can be commonly connected to the source line S1.

In order to display a frame on a general panel, the display polarity of a frame must be switched between a positive polarity and a negative polarity every a certain time so as to avoid the liquid crystal molecules from incorrect rotating, failing to responding to the changes of electrical fields and incorrect displaying corresponding to a given gray level voltage. This is because the liquid crystal molecules are applied with a certain voltage for a long period of time. To solve the above-mentioned problem, every output terminal to source channel of a driver must provides two outputs of positive polarity and negative polarity, which is called as a dot-inversion driving mechanism. FIG. 2 is a diagram of a conventional pixel circuit with dot-inversion driving mechanism. Referring to FIG. 2, each of all the source channel output terminals CH 1-CH N of a driver 120 alternately outputs a positive polarity and a negative polarity by means of a P-polarity digital-to-analog converter (P DAC) 124, an N-polarity digital-to-analog converter (N DAC) 126 and a multiplexer 128 for polarity selection. For example, a driving circuit with 600 channels requires 600 devices of P DACs 124 and 600 devices of N DACs 126, so that each channel output terminal is able to produce two kinds of voltage signals with different polarities sent to the corresponding pixels Dot 1-Dot N of a pixel array 122, which are, for example, corresponding to a scan line.

The conventional schemes for altering the polarity include a popular scheme termed as dot-inversion driving mechanism. With the dot-inversion driving mechanism, the signal voltage polarities of a display dot of a display frame are alternately presented as PNPN . . . , where an architecture in P-N common mode is preferred to save the number of the employed DACs. FIG. 3 is a diagram of a conventional pixel circuit with dot-inversion driving mechanism showing how the number of the employed DACs can be saved. Referring to FIG. 3, corresponding to each of the channel output terminals CH 1-CH N in a driving circuit 130, a P DAC 132 and an N DAC 134 are alternately and sequentially on duty so as to provide a positive polarity and an negative polarity to the pixel unit 136. The pixel unit 136 has, for example, M pieces of gate lines Gate 1-Gate M, wherein each gate line is corresponding to N pixels Dot 1-Dot N. When one of the gate lines Gate 1-Gate M turns on the transistor connected thereto, the gray level voltage signal output from the driving circuit 130 is input to the source of a corresponding transistor, and the polarity of the voltage signal is altered between positive polarity and negative polarity.

FIG. 4 is a diagram of the circuit of FIG. 3 in P-N common connection status. Referring to FIG. 4, when the pixel unit 136 displays a next image frame, a dot-inversion process is conducted; that is, an employed interleave switch makes the P DAC 132 connected to CH2 and the N DAC 134 is connected to CH1 in P-N common mode. In comparison with the circuit of FIG. 2, the circuit of FIG. 4 can save the number of the DACs by a half.

In the prior art, the dual-gate driving mechanism is also used. FIG. 5 is a diagram of a conventional pixel circuit with dual-gate driving mechanism. Referring to FIG. 5, on a display panel with dual-gate driving mechanism 158, the odd pixels and the even pixels are respectively wired, wherein the odd pixels Dot 1, Dot 3 . . . are controlled by odd gate lines 166, and the even pixels Dot 2, Dot 4 . . . are controlled by even gate lines 168. The driving circuit 150 is similar to the driving circuit 120 of FIG. 2; that is, each of channel output terminals CH 1-CH N is corresponding to a P DAC 152, an N DAC 154 and a multiplexer 156. In addition, the sources of two driving transistors corresponding to the odd pixel Dot 1 and the even pixel Dot 2 share a common channel output terminal CH1. In this way, each gray level voltage of the gate line 166 has a same N polarity of a same P polarity, and the next image is displayed in line inversion manner.

If the above-mentioned driving circuit with non-supporting dual-gate driving mechanism is used to display dot-inversion frames, the P-N common mode makes the number of the DACs saved by a half. However, the wires of a panel driven by a driving circuit with the dual-gate driving mechanism are divided into two groups respectively targeting the odd dots and the even dots, which leads the channel output terminals output voltages in a same positive polarity P or in a same negative polarity N to the odd dots, while the voltages output to the even dots are the opposite thereto.

It can be seen from the above described that a driving circuit 150 with the dual-gate driving mechanism is unable to simultaneously support the dot-inversion driving mechanism; that is, the driving circuit 150 is unable to adopt an architecture in P-N common mode to share the employed DACs as the dual-gate driving mechanism as shown in FIGS. 3 and 4. Therefore, the driving circuit of FIG. 5 is unable to save the number of the employed DACs.

### SUMMARY OF THE INVENTION

Accordingly, the present invention is directed to a pixel-driving method and the circuit thereof, which allow simultaneously supporting the dual-gate driving mechanism and the dot-inversion driving mechanism.

The present invention provides a pixel-driving method, which includes defining four continuous pixels as a driving sub-unit sequentially having a first pixel transistor, a second pixel transistor, a third pixel transistor and a fourth pixel transistor; using a first gate line to commonly control the two gates of the first pixel transistor and the fourth pixel transistor; using a second gate line to commonly control the two gates of the second pixel transistor and the third pixel transistor; using a first source line to commonly control the two sources of the first pixel transistor and the second pixel transistor; using a second source line to commonly control the two sources of the third pixel transistor and the fourth pixel transistor. In addition, a positive voltage and a negative voltage are alternately and respectively according to a timing applied to the first source line and the second source line, and an enabling voltage is alternately and respectively according to a timing applied to the first gate line and the second gate line.

The present invention provides another pixel-driving method, which includes defining four continuous pixels as a driving sub-unit sequentially having a first pixel, a second pixel, a third pixel and a fourth pixel; alternately and respectively according to a timing applying a positive driving voltage and a negative driving voltage to the first pixel and the fourth pixel both composing a first set; alternately and respectively according to a timing applying a positive driving voltage and a negative driving voltage to the second pixel and the third pixel both composing a second set.

The present invention also provides a pixel-driving circuit, which is able to make the dot-inversion driving mechanism and the dual-gate driving mechanism compatible with each other. In the pixel-driving circuit, four continuous pixels are defined as a driving sub-unit sequentially having a first pixel, a second pixel, a third pixel and a fourth pixel. The pixel-driving circuit includes a first pixel transistor, a second pixel transistor, a third pixel transistor and a fourth pixel transistor, which are respectively disposed in the first pixel, the second pixel, the third pixel and the fourth pixel. In addition, a first gate line is connected to the two gates of the first pixel transistor and the fourth pixel transistor; a second gate line is connected to the two gates of the second pixel transistor and the third pixel transistor; a first source line is connected to the two sources of the first pixel transistor and the second pixel transistor; a second gate line is connected to the two sources of the third pixel transistor and the fourth pixel transistor. A positive voltage and a negative voltage are alternately and respectively according to a timing applied to the first source line and the second source line.

The present invention provides yet another pixel-driving method, which includes defining four continuous pixels as a driving sub-unit sequentially having a first pixel transistor, a second pixel transistor, a third pixel transistor and a fourth pixel transistor; using a first gate line to commonly control the two gates of the first pixel transistor and the second pixel transistor; using a second gate line to commonly control the two gates of the third pixel transistor and the fourth pixel transistor; using a first source line to commonly control the two sources of the first pixel transistor and the third pixel transistor; using a second source line to commonly control the two sources of the second pixel transistor and the fourth pixel transistor. In addition, a positive voltage and a negative voltage are alternately and respectively according to a timing applied to the first source line and the second source line, and an enabling voltage is alternately and respectively according to a timing applied to the first gate line and the second gate line.

The present invention also provides another pixel-driving circuit, wherein four continuous pixels are defined as a driving sub-unit sequentially having a first pixel, a second pixel, a third pixel and a fourth pixel. The pixel-driving circuit includes a first pixel transistor, a second pixel transistor, a third pixel transistor and a fourth pixel transistor, which are respectively disposed in the first pixel, the second pixel, the third pixel and the fourth pixel. In addition, a first gate line is connected to the two gates of the first pixel transistor and the second pixel transistor; a second gate line is connected to the two gates of the third pixel transistor and the fourth pixel transistor; a first source line is connected to the two sources of the first pixel transistor and the third pixel transistor; a second gate line is connected to the two sources of the second pixel transistor and the fourth pixel transistor. A positive voltage and a negative voltage are alternately and respectively according to a timing applied to the first source line and the second source line.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of a conventional pixel circuit.

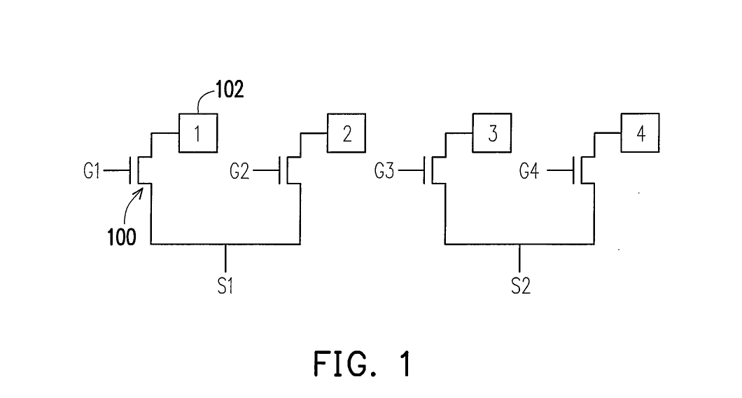

FIG. 2 is a diagram of a conventional pixel circuit with dot-inversion driving mechanism.

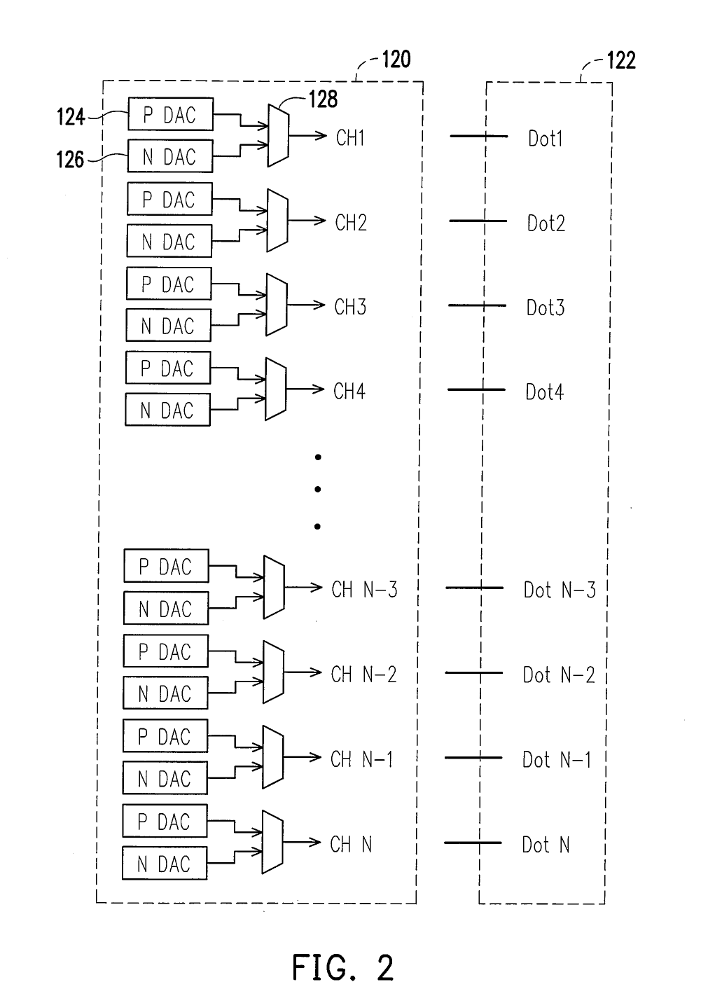

FIG. 3 is a diagram of a conventional pixel circuit with dot-inversion driving mechanism showing how the number of the employed DACs can be saved.

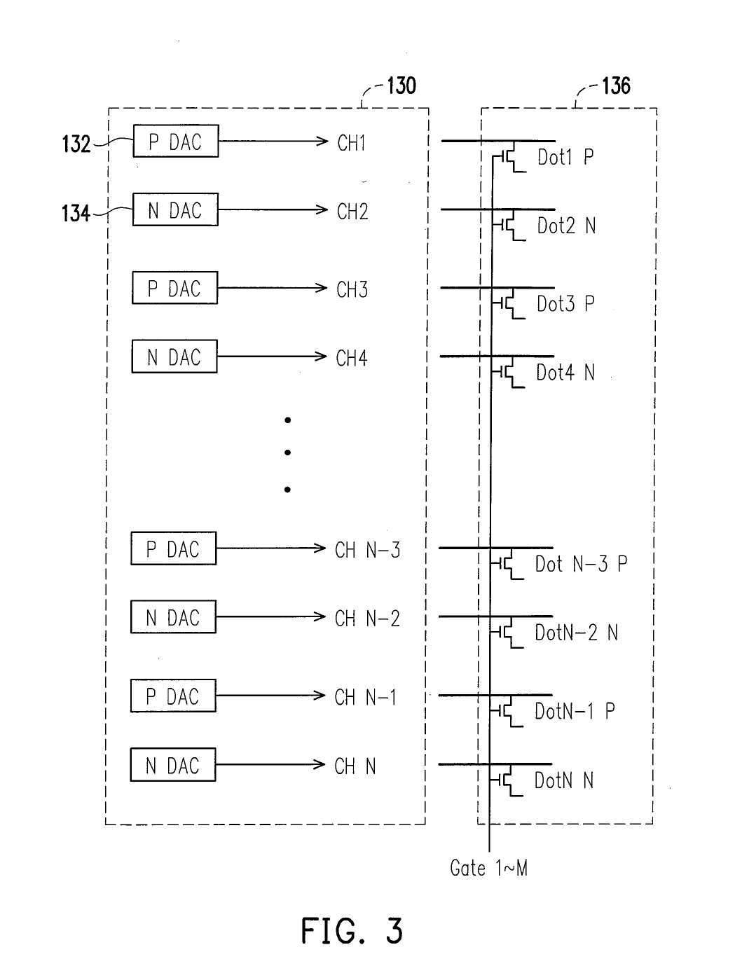

FIG. 4 is a diagram of the circuit of FIG. 3 in P-N common connection status.

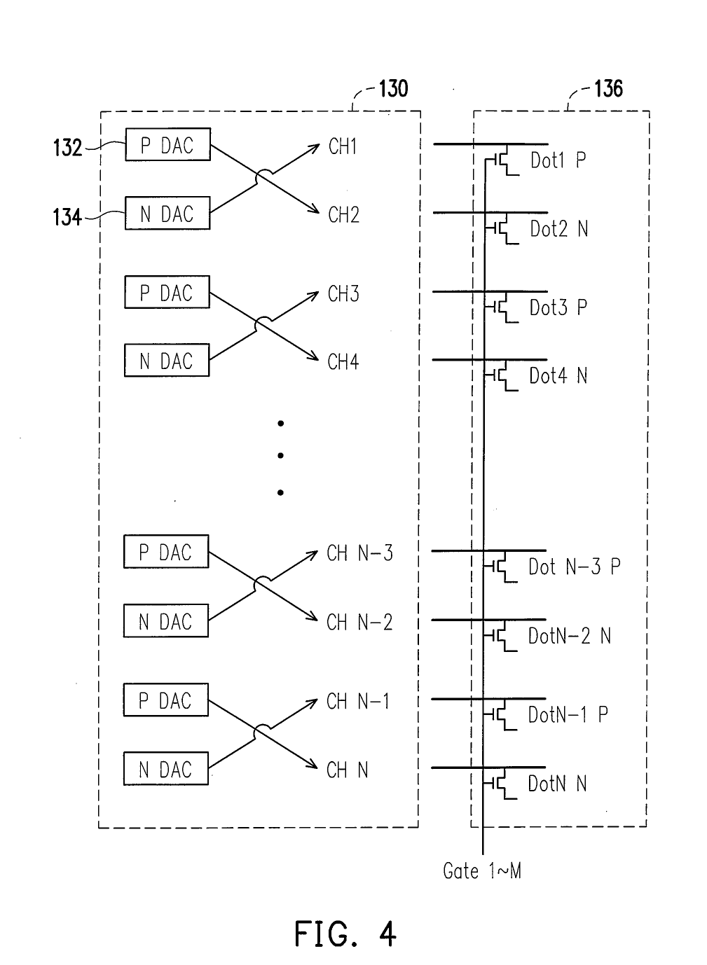

FIG. 5 is a diagram of a conventional pixel circuit with dual-gate driving mechanism.

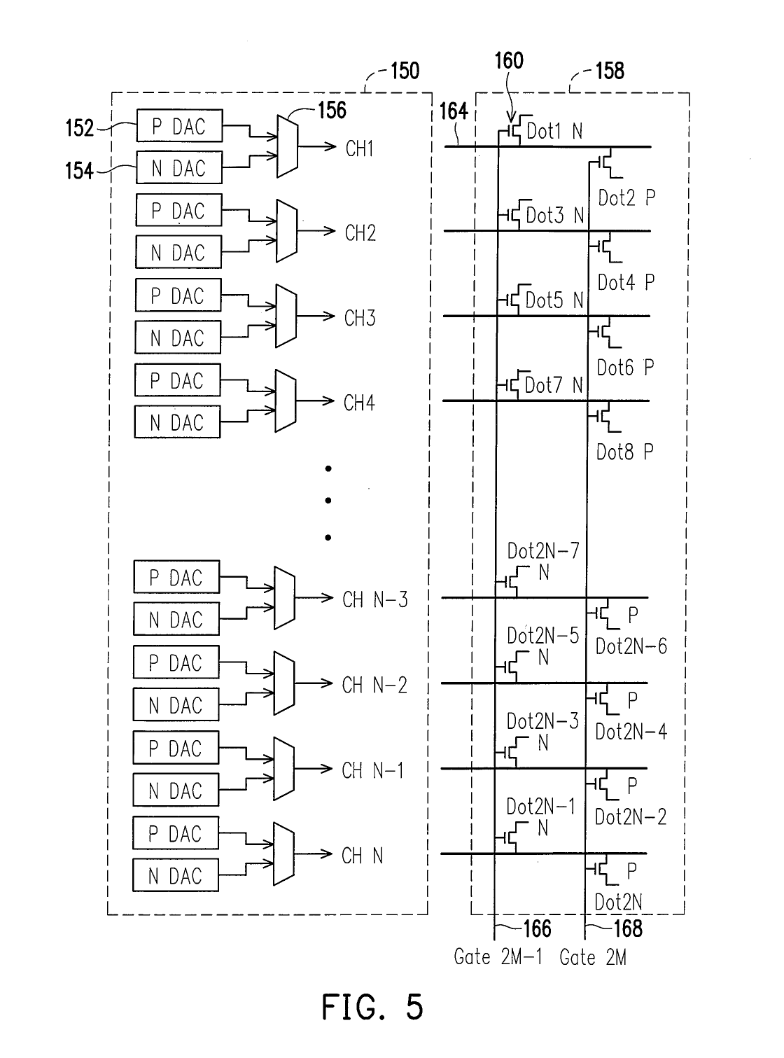

FIG. 6 is a diagram of a pixel-driving circuit according to an embodiment of the present invention.

FIG. 7 is a diagram of the pixel-driving circuit of FIG. 6 in a next display timing status.

FIG. 8 is a diagram of a pixel-driving circuit showing the pixel-driving mechanism thereof according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

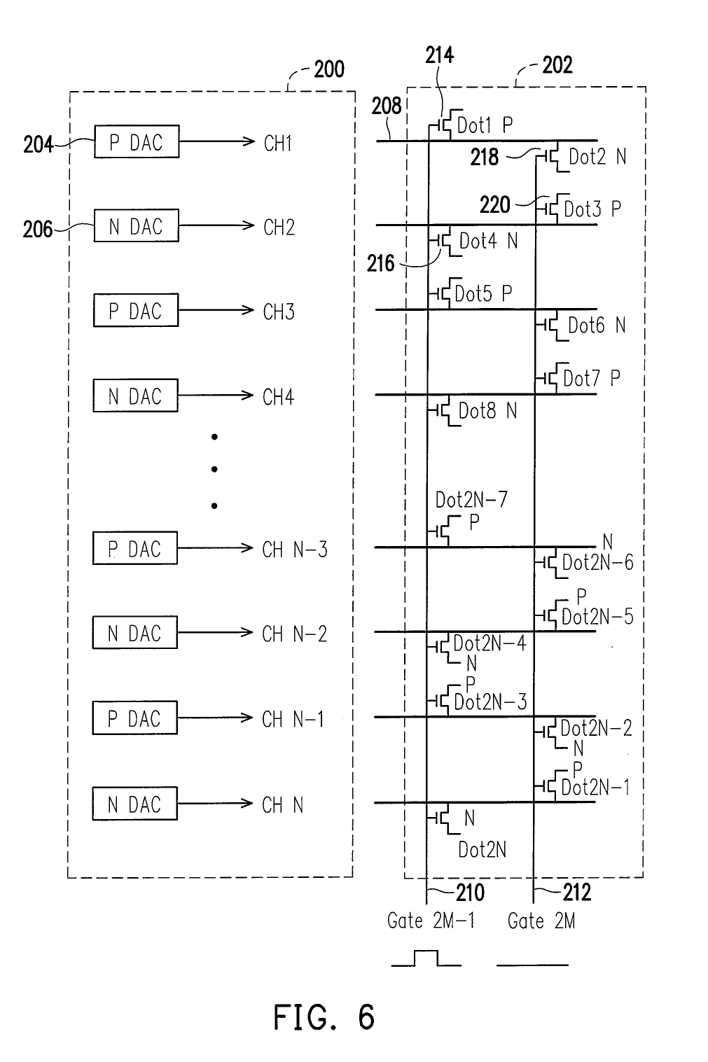

The present invention is able to solve the conventional problem that the dual-gate driving mechanism is not simultaneously compatible with the dot-inversion driving mechanism for driving pixels of a display panel. FIG. 6 is a diagram of a pixel-driving circuit according to an embodiment of the present invention. Referring to FIG. 6, the channel output terminals of the driving circuit 200 includes a plurality of P DAC 204 and a plurality of N DAC 206 in alternative disposition, which satisfies a dot-inversion driving mechanism with common use of DAC. By using, for example, an interleave switch, the P DAC 204 and the N DAC 206 alternately output gray level voltages to a pixel of a pixel array 202. The pixels of the pixel array are configured into a plurality of driving sub-units, wherein a driving sub-unit is composed of four continuous pixels, that is, sequentially composed of a first pixel, a second pixel, a third pixel and a fourth pixel. In addition, a first pixel transistor 214, a second pixel transistor 216, a third pixel transistor 220 and a fourth pixel transistor 216 are respectively disposed in the first pixel, the second pixel, the third pixel and the fourth pixel. A first gate line 210 is connected to the two gates of the first pixel transistor 214 and the fourth pixel transistor 216; a second gate line 212 is connected to the second pixel transistor 218 and the third pixel transistor 220; a first source line 208 corresponding to the channel output terminal CH 1 is connected to the two sources of the first pixel transistor 214 and the second pixel transistor 218; a second source line 208 corresponding to the channel output terminal CH 2 is connected to the two sources of the third pixel transistor 220 and the fourth pixel transistor 216.

In terms of the circuit operation, the first source line 208 is coupled to the P DAC 204 and the second source line 208 is coupled to the N DAC 206 by using an interleave switch. The wiring shown by FIG. 6 is corresponding to a timing status, where an enabling voltage is input to, for example, an odd gate line 210, and the transistors 218 and 216 both connected to the gate line 210 are thereby turned on so as to respectively receive a positive polarity (P) gray level voltage and a negative polarity (N) gray level voltage; meanwhile, another even gate line 212 keeps off.

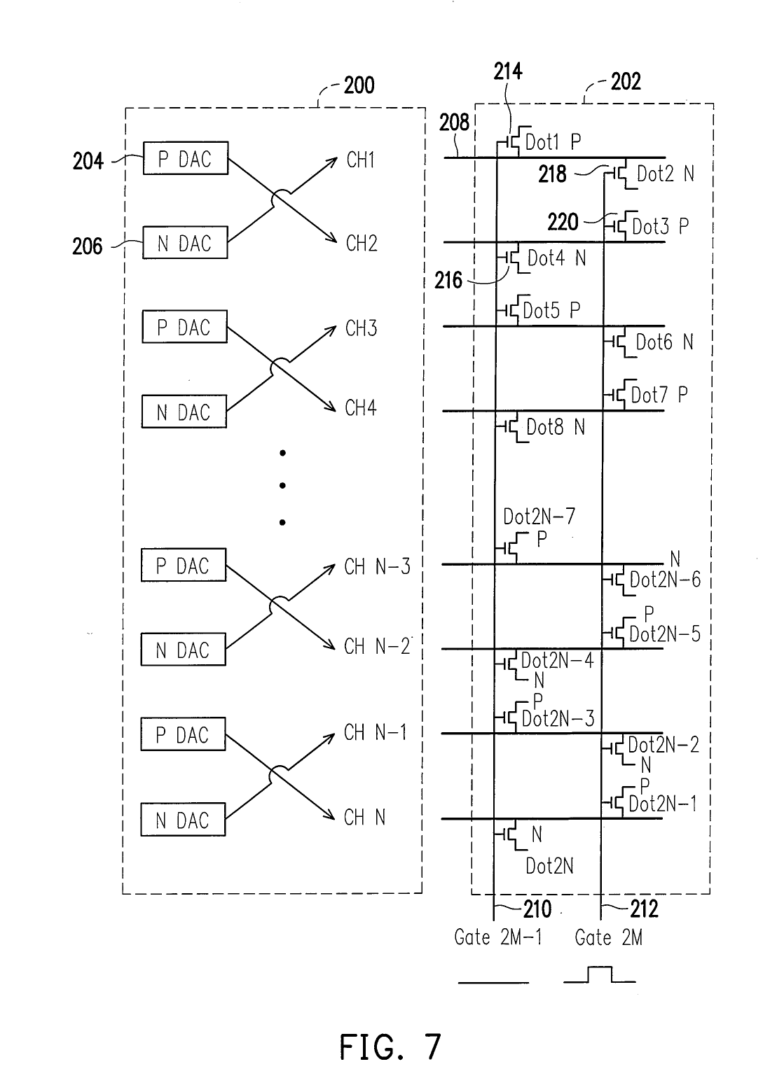

Based on the dual-gate driving mechanism, the circuit of the next display timing makes the pixels on the even gate line 212 displayed. FIG. 7 is a diagram of the pixel-driving circuit of FIG. 6 in a next display timing status. Referring to FIG. 7, when the pixels on the even gate line 212 display an image, the odd gate line 210 keeps off. At this time, the dot-inversion driving mechanism employed by the driving circuit 200 uses the same interleave switch to make the output from the P DAC 204 sent to the channel output terminal CH 2 so as to input the positive polarity voltage to the transistors 216 and 220 of the second source line 208. In contrast, the output from the N DAC 206 is sent to the channel output terminal CH 1 and a negative polarity voltage is input to the transistors 214 and 218 of the first source line 208. According to the above described, the driving circuit of the present invention implements both the dot-inversion driving mechanism and the dual-gate driving mechanism compatible with each other.

It can be seen from the above-described operation that the circuit alternately and sequentially applies a positive voltage and a negative voltage respectively to the first source line and the second source line. Besides, the circuit follows a certain timing to alternately and sequentially apply an enabling voltage respectively to the first gate line 210 and the second gate line 212.

The above-described operation is exemplarily corresponding to a driving sub-unit composed of four pixels. To drive pixels with more gate lines, for example, with three gate lines, similarly, six pixels are defined as a driving sub-unit, but the operation principle is still based on the above-mentioned operation for four pixels. In addition, the above-mentioned ‘even’, ‘odd’, ‘P DAC’ or ‘N DAC’ are for simplifying the depiction of the embodiment; the sequence thereof can be interchanged, which would not change the driving mechanisms of the present invention.

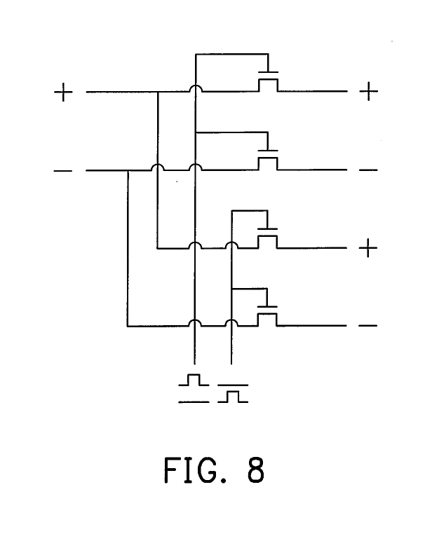

The driving circuit of the present invention allows to be modified similarly to the above-described mechanisms. FIG. 8 is a diagram of a pixel-driving circuit showing the pixel-driving mechanism thereof according to an embodiment of the present invention. Referring to FIG. 8, the pixel-driving circuit is able to make the dot-inversion driving mechanism and the dual-gate driving mechanism compatible with each other as well. Four continuous pixels herein are defined as a driving sub-unit sequentially having a first pixel, a second pixel, a third pixel and a fourth pixel. The pixel-driving circuit includes a first pixel transistor, a second pixel transistor, a third pixel transistor and a fourth pixel transistor, which are respectively disposed in the first pixel, the second pixel, the third pixel and the fourth pixel. In addition, a first gate line is connected to the two gates of the first pixel transistor and the second pixel transistor; a second gate line is connected to the two gates of the third pixel transistor and the fourth pixel transistor; a first source line is connected to the two sources of the first pixel transistor and the third pixel transistor; a second gate line is connected to the two sources of the second pixel transistor and the fourth pixel transistor. A positive voltage and a negative voltage are alternately and respectively according to a timing applied to the first source line and the second source line.

In terms of the circuit operation, first, when the first gate line turns on the first and second pixel transistors according to a timing, the gray level voltages thereof respectively keep positive polarity and negative polarity. At the next timing, the second gate line turns on the third and fourth pixel transistors, and the gray level voltages keep at the positive polarity and the negative polarity unchanged. At the third timing, the first gate line is started and meanwhile the polarities of the sources would be exchanged with each other as above described. Thus, the circuit of the embodiment works at the time with the dot-inversion driving mechanism.

In fact, the above-described circuit implements the pixel-driving method of the present invention, but the circuit having the required functions allows to be modified.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A pixel-driving method able to make dot-inversion driving mechanism and dual-gate driving mechanism compatible with each other; the method comprising:
defining four continuous pixels as a driving sub-unit, wherein the four continuous pixels sequentially have a first pixel transistor, a second pixel transistor, a third pixel transistor and a fourth pixel transistor, wherein the two gates of the first pixel transistor and the fourth pixel transistor are connected to each other; the two gates of the second pixel transistor and the third pixel transistor are connected to each other; the two sources of the first pixel transistor and the second pixel transistor are connected to each other; the two sources of the third pixel transistor and the fourth pixel transistor are connected to each other;
using a first gate line to commonly control the two gates of the first pixel transistor and the fourth pixel transistor;
using a second gate line to commonly control the two gates of the second pixel transistor and the third pixel transistor;
using a first source line to commonly control the two sources of the first pixel transistor and the second pixel transistor;
using a second source line to commonly control the two sources of the third pixel transistor and the fourth pixel transistor;
alternately and respectively according to a timing applying a positive voltage and a negative voltage to the first source line and the second source line; and
alternately and respectively according to a timing applying an enabling voltage to the first gate line and the second gate line.

2. The pixel-driving method according to claim 1, wherein the first gate line and the second gate line are for turning on the pixel transistors connected to the first and second gate lines.

3. The pixel-driving method according to claim 1, wherein once the first gate line or the second gate line is enabled, two voltage polarities of the first source line and the second source line are inverted.

4. The pixel-driving method according to claim 1, wherein once the first gate line or the second gate line is enabled, a half of the pixels on a scan line corresponding to the first gate line or the second gate line are started.

5. A pixel-driving method able to make dot-inversion driving mechanism and dual-gate driving mechanism compatible with each other; the method comprising:
defining four continuous pixels as a driving sub-unit, wherein the driving sub-unit sequentially has a first pixel, a second pixel, a third pixel and a fourth pixel, wherein the two gates of the first pixel transistor and the fourth pixel transistor are connected to each other; the two gates of the second pixel transistor and the third pixel transistor are connected to each other; the two sources of the first pixel transistor and the second pixel transistor are connected to each other; the two sources of the third pixel transistor and the fourth pixel transistor are connected to each other;
taking the first pixel and the fourth pixel as a first set, and alternately and respectively according to a timing applying a positive driving voltage and a negative driving voltage to the first pixel and the fourth pixel; and
taking the second pixel and the third pixel as a second set, and alternately and respectively according to a timing applying a positive driving voltage and a negative driving voltage to the second pixel and the third pixel.

6. The pixel-driving method according to claim 5, wherein the first gate line and the second gate line are for turning on the pixel transistors connected to the first and second gate lines.

7. The pixel-driving method according to claim 5, wherein once the first gate line or the second gate line is enabled, two voltage polarities of the first source line and the second source line are inverted.

8. The pixel-driving method according to claim 5, wherein once the first gate line or the second gate line is enabled, a half of the pixels on a scan line corresponding to the first gate line or the second gate line are started.

9. A pixel-driving circuit able to make dot-inversion driving mechanism and dual-gate driving mechanism compatible with each other, wherein four continuous pixels are defined as a driving sub-unit sequentially having a first pixel, a second pixel, a third pixel and a fourth pixel; the pixel-driving method; the pixel-driving circuit comprising:
a first pixel transistor, a second pixel transistor, a third pixel transistor and a fourth pixel transistor, which are respectively disposed in the first pixel, the second pixel, the third pixel and the fourth pixel, wherein the two gates of the first pixel transistor and the fourth pixel transistor are connected to each other; the two gates of the second pixel transistor and the third pixel transistor are connected to each other; the two sources of the first pixel transistor and the second pixel transistor are connected to each other; the two sources of the third pixel transistor and the fourth pixel transistor are connected to each other;
a first gate line, connected to the two gates of the first pixel transistor and the fourth pixel transistor;
a second gate line, connected to the two gates of the second pixel transistor and the third pixel transistor;
a first source line, connected to the two sources of the first pixel transistor and the second pixel transistor; and
a second gate line, connected to the two sources of the third pixel transistor and the fourth pixel transistor,
wherein a positive voltage and a negative voltage are alternately and respectively according to a timing applied to the first source line and the second source line.

10. The pixel-driving circuit according to claim 9, further comprising:
a positive voltage digital-to-analog converter;
a negative voltage digital-to-analog converter; and
an interleave switch, having a terminal connected to the first source line and the second source line and another terminal connected to the positive voltage digital-to-analog converter and the negative voltage digital-to-analog converter.

11. The pixel-driving circuit according to claim 9, wherein the positive voltage digital-to-analog converter and the negative voltage digital-to-analog converter respectively receive a corresponding pixel data, followed by converting the pixel data into an analog voltage.

12. The pixel-driving circuit according to claim 9, wherein the first gate line and the second gate line are for turning on the pixel transistors connected to the first and second gate lines.

13. The pixel-driving circuit according to claim 9, wherein once the first gate line or the second gate line is enabled, two voltage polarities of the first source line and the second source line are inverted.

14. The pixel-driving circuit according to claim 9, wherein the first gate line and the second gate line are respectively connected to a half of the pixels on a scan line.

15. A pixel-driving method able to make dot-inversion driving mechanism and dual-gate driving mechanism compatible with each other; the method comprising:
defining four continuous pixels as a driving sub-unit, wherein the four continuous pixels sequentially have a first pixel transistor, a second pixel transistor, a third pixel transistor and a fourth pixel transistor, wherein the two gates of the first pixel transistor and the fourth pixel transistor are connected to each other; the two gates of the second pixel transistor and the third pixel transistor are connected to each other; the two sources of the first pixel transistor and the second pixel transistor are connected to each other; the two sources of the third pixel transistor and the fourth pixel transistor are connected to each other;
using a first gate line to commonly control the two gates of the first pixel transistor and the second pixel transistor;
using a second gate line to commonly control the two gates of the third pixel transistor and the fourth pixel transistor;
using a first source line to commonly control the two sources of the first pixel transistor and the third pixel transistor;
using a second source line to commonly control the two sources of the second pixel transistor and the fourth pixel transistor;
alternately and respectively according to a timing applying a positive voltage and a negative voltage to the first source line and the second source line; and
alternately and respectively according to a timing applying an enabling voltage to the first gate line and the second gate line.

16. The pixel-driving method according to claim 15, wherein the first gate line and the second gate line are for turning on the pixel transistors connected to the first and second gate lines.

17. The pixel-driving method according to claim 15, wherein once the first gate line is enabled, two voltage polarities of the first source line and the second source line are inverted.

18. The pixel-driving method according to claim 15, wherein once the second gate line is enabled, two voltage polarities of the first source line and the second source line are inverted.

19. A pixel-driving circuit able to make dot-inversion driving mechanism and dual-gate driving mechanism compatible with each other, wherein four continuous pixels are defined as a driving sub-unit sequentially having a first pixel, a second pixel, a third pixel and a fourth pixel; the pixel-driving method; the pixel-driving circuit comprising:
a first pixel transistor, a second pixel transistor, a third pixel transistor and a fourth pixel transistor, which are respectively disposed in the first pixel, the second pixel, the third pixel and the fourth pixel, wherein the two gates of the first pixel transistor and the second pixel transistor are connected to each other; the two gates of the third pixel transistor and the fourth pixel transistor are connected to each other; the two sources of the first pixel transistor and the third pixel transistor are connected to each other; the two sources of the second pixel transistor and the fourth pixel transistor are connected to each other;
a first gate line, connected to the two gates of the first pixel transistor and the second pixel transistor;
a second gate line, connected to the two gates of the third pixel transistor and the fourth pixel transistor;
a first source line, connected to the two sources of the first pixel transistor and the third pixel transistor; and
a second gate line, connected to the two sources of the second pixel transistor and the fourth pixel transistor,
wherein a positive voltage and a negative voltage are alternately and respectively according to a timing applied to the first source line and the second source line.

20. The pixel-driving circuit according to claim 19, wherein once the first gate line is enabled, two voltage polarities of the first source line and the second source line are inverted.
